(19) United States
(12) Patent Application Publication
(10) Pub. No.: US 2007/0132769 A1
(43) Pub. Date: Jun. 14, 2007

(54) DATA PROCESSING APPARATUS, JOB PROCESSING METHOD, INFORMATION PROCESSING APPARATUS, INFORMATION PROCESSING METHOD, AND PROGRAM

(75) Inventors: Akinori Takeo, Kanagawa (JP); Tomoko Adachi, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Ohta-ku (JP)

(21) Appl. No.: 11/673,338

(22) Filed: Feb. 9, 2007

Related U.S. Application Data
(62) Division of application No. 10/357,194, filed on Feb. 4, 2003.

(30) Foreign Application Priority Data
Feb. 14, 2002 (JP) 2002-037012

(51) Int. Cl. G06F 13/14

(52) U.S. Cl. 345/520

(57) ABSTRACT

When there are a plurality of kinds of starting modes in which conditions to start a process of a job are different, a device driver of an information processing apparatus can recognize the starting modes which can be designated by a peripheral apparatus.

### BACKGROUND OF THE INVENTION

1. Field of the Invention

The invention relates to a peripheral apparatus for receiving a job from an information processing apparatus by communication via a network and processing it, the information processing apparatus for communicating with the peripheral apparatus, a job processing method, a memory medium, and a program.

2. Related Background Art

Hitherto, a peripheral apparatus for receiving a job from an information processing apparatus by communication via a network and processing it, for example, a peripheral apparatus which can execute a multifunction process of a printer, a scanner, a copying apparatus, a FAX, and the like has been proposed.

When a job (including, for example, a print job, a scanner job, a copy job, a facsimile job, etc.) is inputted from the information processing apparatus to such a peripheral apparatus, in the peripheral apparatus, a job process is managed in a manner such that the received job is immediately executed or, if the user designates time, the job is spooled into memory resources until the designated time comes, and thereafter, the job is executed when the designated time comes.

### SUMMARY OF THE INVENTION

However, the reason why the user can designate the time as a starting mode of the job process is that driver software implemented in the information processing apparatus has previously recognized that the time can be designated as a job process starting mode of the apparatus, and in the case of driver software which does not have a knowledge of the apparatus, there is a problem such that even a fact that the foregoing function of the apparatus on the network can be designated cannot be presented to the user, so that the user of the information processing apparatus is in a job processing environment in which he cannot request the job process accompanied with the designation of the starting time of the job process and he cannot execute the job process effectively using the function of the peripheral apparatus.

The invention is made to solve the above problem and it is the first object of the invention that when a peripheral apparatus has a plurality of starting modes, a device driver or a software program on an information processing apparatus can recognize the starting modes provided for the peripheral apparatus, that is, the starting modes which can be designated by the peripheral apparatus.

The second object of the invention is that a device driver or a software program easily recognizes the presence or absence of starting modes provided for a peripheral apparatus, presents the starting modes which can be designated by the peripheral apparatus to the user, and can freely designate a starting mode desired by him.

### BRIEF DESCRIPTION OF THE DRAWINGS

FIG. 1 is a block diagram for explaining a construction of a peripheral apparatus showing an embodiment of the invention;

FIG. 2 is a block diagram showing an example of a detailed construction of a controller shown in FIG. 1;

FIG. 3 is a diagram showing an example of a construction of a network system in which the peripheral apparatus shown in FIG. 1 operates;

FIG. 4 is a block diagram for explaining a construction of an information processing apparatus showing the embodiment of the invention;

FIG. 5 is a diagram showing an example of a construction of a job which is processed by the peripheral apparatus shown in FIG. 1;

FIG. 6 is a diagram showing an example of a “list of attributes supported by the job” as an attribute list of the job held in the peripheral apparatus shown in FIG. 1;

FIG. 7 is a diagram showing an example of a “list of attributes which can be designated as a starting mode of a job process” held in the peripheral apparatus shown in FIG. 1;

FIG. 8 is a flowchart showing an example of a first data processing procedure in the information processing apparatus according to the invention;

FIG. 9 is a diagram showing an example of a first user interface which is displayed on a display apparatus on each PC shown in FIG. 3;

FIG. 10 is a diagram showing an example of a second user interface which is displayed on the display apparatus on each PC shown in FIG. 3;

FIG. 11 is a flowchart showing an example of a second data processing procedure in the information processing apparatus according to the invention;

FIG. 12 is a flowchart showing an example of a third data processing procedure in the information processing apparatus according to the invention;

FIG. 13 is a flowchart showing an example of a first data processing procedure in the peripheral apparatus according to the invention;

FIG. 14 is a flowchart showing an example of a second data processing procedure in the peripheral apparatus according to the invention;

FIG. 15 is a flowchart showing an example of a third data processing procedure in the peripheral apparatus according to the invention; and

FIG. 16 is a diagram for explaining a memory map of a memory medium for storing various data processing programs which can be read out by an image processing system to which the information processing apparatus and the peripheral apparatus according to the invention can be applied.

### DETAILED DESCRIPTION OF THE PREFERRED EMBODIMENT

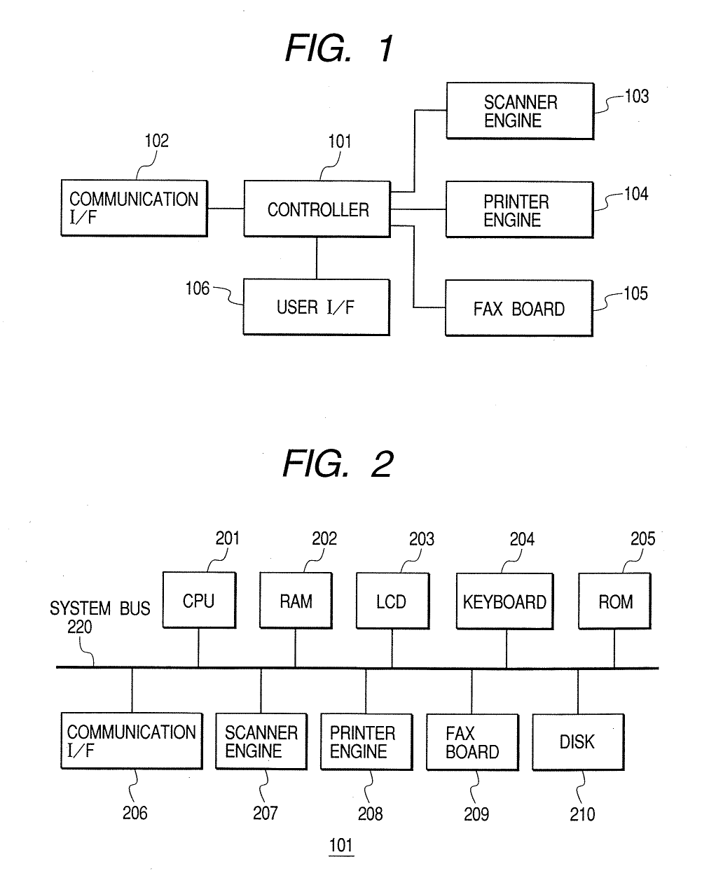

FIG. 1 is a block diagram for explaining a construction of a peripheral apparatus showing an embodiment of the invention and corresponds to the case where the apparatus has a multifunction including a scanner function, a printer function, and a facsimile function.

In FIG. 1, reference numeral 101 denotes a controller for controlling the peripheral apparatus and has a hardware construction as shown in FIG. 2. Reference numeral 102 denotes a communication interface (I/F) for allowing the controller 101 to communicate with the outside of the peripheral apparatus. For example, an Ethernet (registered trademark) interface, an IEEE1284 interface, or another communication interface can be used as a communication I/F 102.

Reference numeral 103 denotes a scanner engine which is controlled by the controller 101. Reference numeral 104 denotes a printer engine which is controlled by the controller 101. For example, a laser beam printer, an ink jet printer, or another printer can be used as a printer engine 104.

Reference numeral 105 denotes a FAX board for realizing the FAX function such as communication control or the like at the time of the transmission and reception of an image. The FAX board 105 is controlled by the controller 101. Reference numeral 106 denotes a user interface constructed by an LCD display and a keyboard. The user I/F 106 displays information from the controller 101 and transfers an instruction from the user to the controller 101.

The peripheral apparatus having the construction as mentioned above allows the printer engine 104 to be selected and enables a print job to be issued. The peripheral apparatus also allows the printer engine 104 and the scanner engine 103 to be selected and enables a copy job to be issued. The peripheral apparatus further allows the printer engine 104, the scanner engine 103, and the FAX board 105 to be selected and enables a FAX reception job and a FAX transmission job to be issued.

FIG. 2 is a block diagram showing an example of a detailed construction of the controller 101 shown in FIG. 1.

In FIG. 2, in the controller 101 shown in FIG. 1, a CPU 201, a RAM 202, an LCD 203, a keyboard 204, a ROM 205, a communication interface 206, a scanner engine 207, a printer engine 208, a FAX board 209, and a DISK 210 are mutually connected via a system bus 220.

A program to control the controller 101 shown in FIG. 1 has been stored in the ROM 205 or the DISK 210, is read out and stored into the RAM 202 as necessary, and is executed by the CPU 201.

Besides the control program, attribute information showing functions and states of the peripheral apparatuses, attribute information showing functions and states of the jobs which are processed by the peripheral apparatuses, job data serving as a target of an output, and the like have been stored in the ROM 205 or the DISK 210. The CPU 201 allows the LCD 203 to display and receives an instruction of the user via the keyboard 204. The CPU 201 communicates with the outside via the communication I/F 206.

In the embodiment, in the peripheral apparatus shown in FIG. 1, the CPU 201 receives an input of the user from the keyboard 204 via the system bus 220, controls the RAM 202, LCD 203, ROM 205, communication I/F 206, scanner engine 207, printer engine 208, FAX board 209, and DISK 210, and executes a process corresponding to the received input unless otherwise specified.

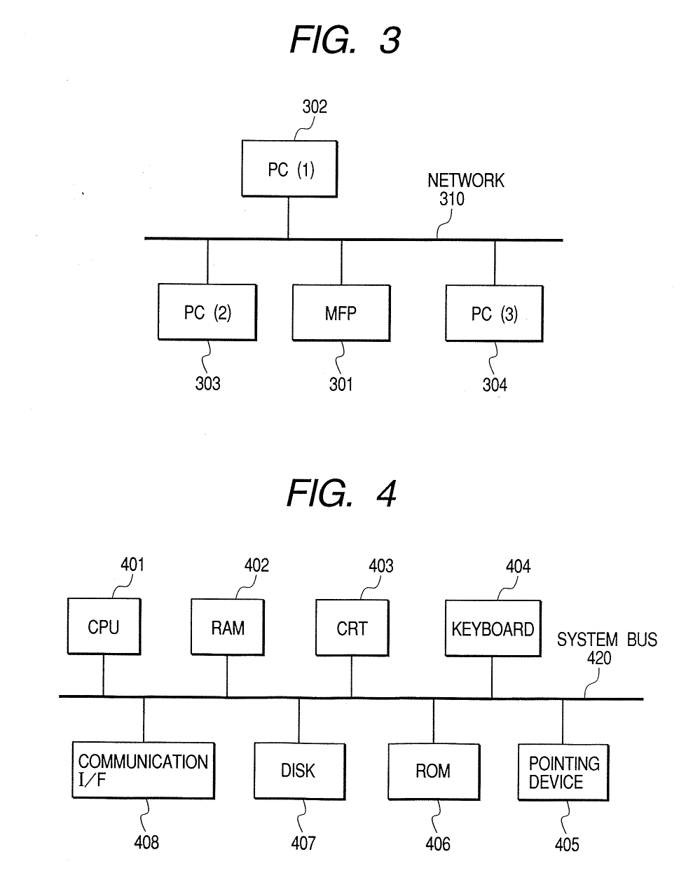

FIG. 3 is a diagram showing an example of a construction of a network system in which the peripheral apparatus shown in FIG. 1 operates.

In FIG. 3, an MFP (Multi Function Peripheral) 301 corresponds to the peripheral apparatus shown in FIG. 1. Each of a PC(1) 302, a PC(2) 303, and a PC(3) 304 has a hardware construction as shown in FIG. 4 and indicates a PC (Personal Computer) connected to the MFP 301 via a network 310.

A workstation, another peripheral apparatus, or another apparatus can be connected to the MFP 301 via the network 310. Driver software can request the MFP 301 via the network 310 from the PC(1), PC(2), or PC(3) to execute a job process such as print, scan, copy, or FAX transmission/reception and can inquire attribute information of the MFP 301.

FIG. 4 is a block diagram for explaining a construction of the information processing apparatus showing the embodiment of the invention and corresponds to the hardware construction of each the PCs constructing the network system shown in FIG. 3.

In FIG. 4, in each PC, a CPU 401, a RAM 402, a CRT 403, a keyboard 404, a pointing device 405, a ROM 406, a DISK 407, and a communication I/F 408 are mutually connected via a system bus 420. A program to control the PC has been stored in the ROM 406 or the DISK 407, is read out and stored into the RAM 402 as necessary, and is executed by the CPU 401.

The CPU 401 allows the CRT 403 to display and receives an instruction of the user from the keyboard 404 or the pointing device 405. The CPU 401 communicates with the outside via the communication I/F 408.

In the embodiment, in the PC shown in FIG. 4, the CPU 401 receives an input of the user from the keyboard 404 or the pointing device 405 via the system bus 420, controls the RAM 402, CRT 403, ROM 406, DISK 407, and communication I/F 408, and executes a process corresponding to the received input unless otherwise specified.

The instruction of the user to the peripheral apparatus in FIG. 1 and the display of the information to the user can be executed via the local user I/F 106 in FIG. 1 or can be executed by an apparatus serving as a client such as PC(l), PC(2), or PC(3) in FIG. 3 connected by the network 310.

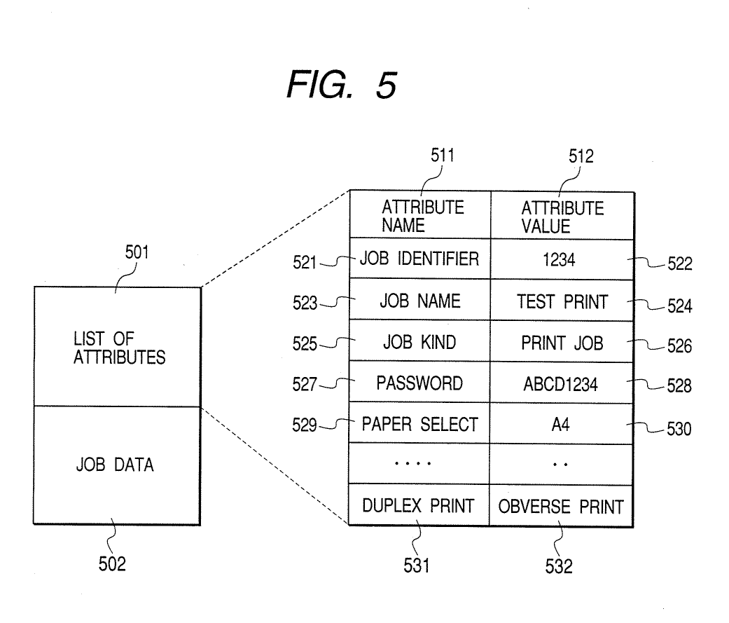

FIG. 5 is a diagram showing an example of a construction of the job which is processed by the peripheral apparatus shown in FIG. 1.

In FIG. 5, the job which is processed by the peripheral apparatus shown in FIG. 1 is constructed by: a list 501 of attributes showing a function and a state of the job; and job data 502 showing data serving as a processing target of the job. The job data 502 is not always necessary in dependence on the kind of job.

The attribute list 501 is a list comprising attribute names and their attribute values as shown at reference numerals 511, 512, and 521 to 532 and indicates the function and the state of the job inputted by the driver software.

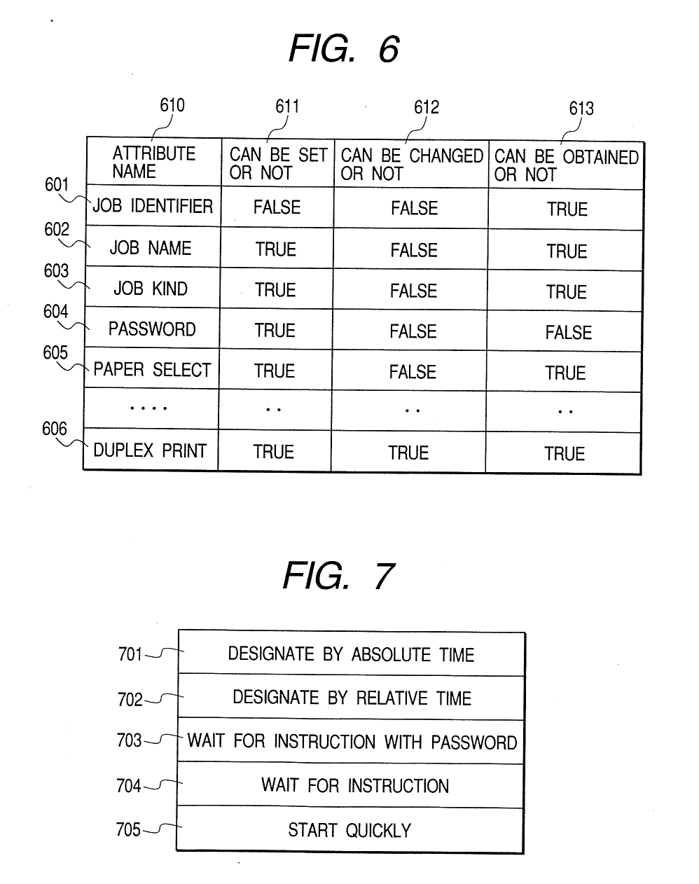

In the attribute list 501, attribute identifiers can be also designated in the column 511 in place of the attribute names. The attributes which are listed in the attribute list 501 are the same as those which are listed in an “attribute list which is supported by the job” shown in FIG. 6. The job data 502 shows the data such as image data or the like serving as a target of the job process. The column 511 shows the attribute names.

The column 512 indicates the attribute values of the attributes shown by the attribute names in the column 511. The attribute 521 shows an identifier of the inputted job and its attribute value 522 shows that “job identifier” is “1234”. The attribute 523 shows a name of the inputted job and its attribute value 524 shows that “job name” is “test print”.

The attribute 525 shows a kind of inputted job such as print job, copy job, or the like and its attribute value 526 shows that “job kind” is “print job”. The attribute 527 shows a job password which is requested at the start of the job process and its attribute value 528 shows that “job password” is “ABCD1234”.

The attribute 529 shows selection of paper which is used in this job and its attribute value 530 shows that “paper select” is “A4”. The attribute 531 shows whether the print surface is only the obverse side, both sides, or only the reverse side in this job and its attribute value 532 shows that “print surface” is “obverse”. In the embodiment, the meanings of each attribute, the attribute name or attribute identifier, and the attribute value have also been well known both in the peripheral apparatus in FIG. 1 and the driver software.

FIG. 6 is a diagram showing an example of a “list of attributes supported by the job” as an attribute list of the job held in the peripheral apparatus shown in FIG. 1 and such an attribute list has been stored in the ROM 205 or the DISK 210 shown in FIG. 2.

The attributes which are listed in the “list of attributes supported by the job” can be the attributes other than the attributes shown in FIG. 6.

In the “list of attributes supported by the job” shown in FIG. 6, all of the attributes held by the job which is processed by the peripheral apparatus are listed. In the “list of attributes supported by the job”, attribute names (column 610) and results of the following discrimination with respect to the attributes are shown: whether the attribute is an attribute whose attribute value can be set by the driver software when the job is inputted or not (column 611); whether the attribute is an attribute whose attribute value can be changed for the job which has already been inputted or not (column 612); and whether the attribute is an attribute whose attribute value can be obtained for the job which has already been inputted or not (column 613). In this case, if the attribute value can be set, changed, or obtained, the column is shown by “TRUE” and if not, the column is shown by “FALSE”, respectively.

A row 601 shows a supporting situation of a “job identifier” attribute. The “job identifier” attribute cannot be set, cannot be changed, and can be obtained. A row 602 shows a supporting situation of a “job name” attribute. The “job name” attribute can be set, cannot be changed, and can be obtained.

A row 603 shows a supporting situation of a “job kind” attribute. The “job kind” attribute can be set, cannot be changed, and can be obtained. A row 604 shows a supporting situation of a “job password” attribute. The “job password” attribute can be set, cannot be changed, and cannot be obtained.

A row 605 shows a supporting situation of a “paper select” attribute. The “paper select” attribute can be set, cannot be changed, and can be obtained. A row 606 shows a supporting situation of a “duplex print” attribute. The “duplex print” attribute can be set, can be changed, and can be obtained.

FIG. 7 is a diagram showing an example of a “list of attributes which can be designated as a starting mode of a job process” held in the peripheral apparatus shown in FIG. 1. This list has been stored in the ROM 205 or the DISK 210 in FIG. 2.

In the “list of attributes which can be designated as a starting mode of a job process” of FIG. 7, attribute values which can be designated by the driver software are listed as values of the “starting mode of a job process” held by the job which is processed by the peripheral apparatus.

The attribute values which are listed in the “list of attributes which can be designated as a starting mode of a job process” can be the attribute values other than the attribute values shown in FIG. 7. In the embodiment, it is assumed that the “starting mode of a job process” attributes have been listed in the “list of attributes supported by the job” in FIG. 6 held by the peripheral apparatus in FIG. 1 and other attributes which are necessary in accordance with the set values of the “starting mode of a job process” attributes have been also listed in the “list of attributes supported by the job” in FIG. 6.

The “starting mode of a job process” attributes show the setting of starting conditions of the job process which is inputted to the peripheral apparatus in FIG. 1 by the driver software. By setting the “starting mode of a job process” attributes, the start of the process of the job which is inputted can be controlled.

In FIG. 7, an attribute value “designate by absolute time” 701 shows that the start time is designated by the absolute time and, when the start time comes, the job process is started. The designated start time is also included in this attribute value. An attribute value “designate by relative time” 702 shows that the start time is designated by the relative time and, when the start time comes, the job process is started. The designated start time is also included in this attribute value.

An attribute value “wait for instruction with password” 703 shows that the apparatus waits for the starting instruction and the starting instruction needs an input of a password by the user and, only when the starting instruction with the correct password is issued, the job process is started. A password which is authenticated in the starting instruction is designated by a “job password” attribute. An attribute value “wait for instruction” 704 shows that the apparatus waits for the starting instruction and when the start is instructed by the user, the job process is started. An attribute value “start quickly” 705 shows that the job process is started as soon as the job is inputted.

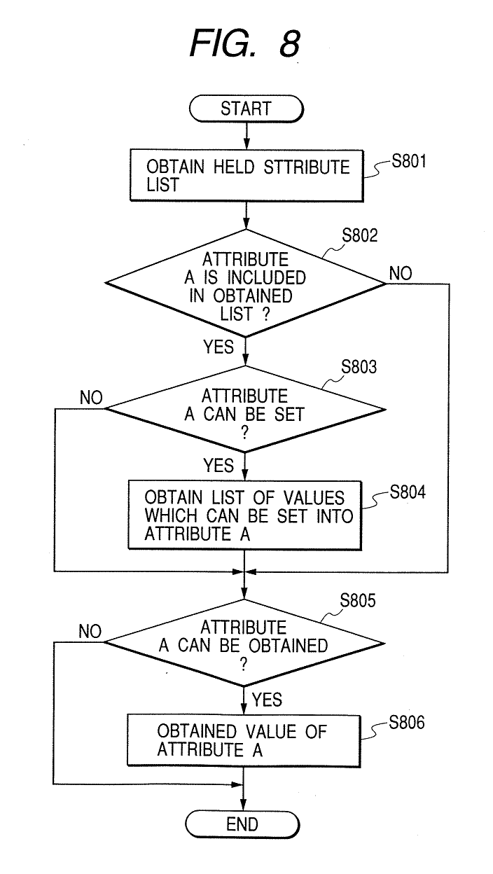

FIG. 8 is a flowchart showing an example of a first data processing procedure in the information processing apparatus according to the invention and corresponds to a processing procedure for inquiring of the peripheral apparatus in FIG. 1 the attribute information of the peripheral apparatus. S801 to S806 denote processing steps.

First, in step S801, the peripheral apparatus is requested to obtain the “list of attributes supported by the job”, thereby obtaining the attribute list. In step S802, whether an attribute A showing the function which is needed by the driver software is included in the “list of attributes supported by the job” obtained in step S801 or not is discriminated. If YES, step S803 follows. If NO, step S805 follows. In step S803, whether the attribute A can be set from the attribute list when the driver software inputs the job or not is discriminated with respect to the attribute A in the attribute list obtained in step S801. If YES, step S804 follows. If NO, step S805 follows. In step S804, a list of the attribute values which can be set into the attribute A is obtained from the peripheral apparatus in FIG. 1 and step S805 follows. In step S805, whether the attribute A is an attribute which can be obtained by the driver software or not is discriminated. If YES, step S806 follows. If NO, the processing routine is finished. In step S806, the peripheral apparatus is requested to obtain the value of the attribute A and the value of the attribute A is obtained. The processing routine is finished.

By the above processes, the driver software can obtain information showing what kind of attribute the job which is processed by the peripheral apparatus in FIG. 1 holds and which attribute value can be designated with respect to each attribute. Which value each attribute has can be also obtained.

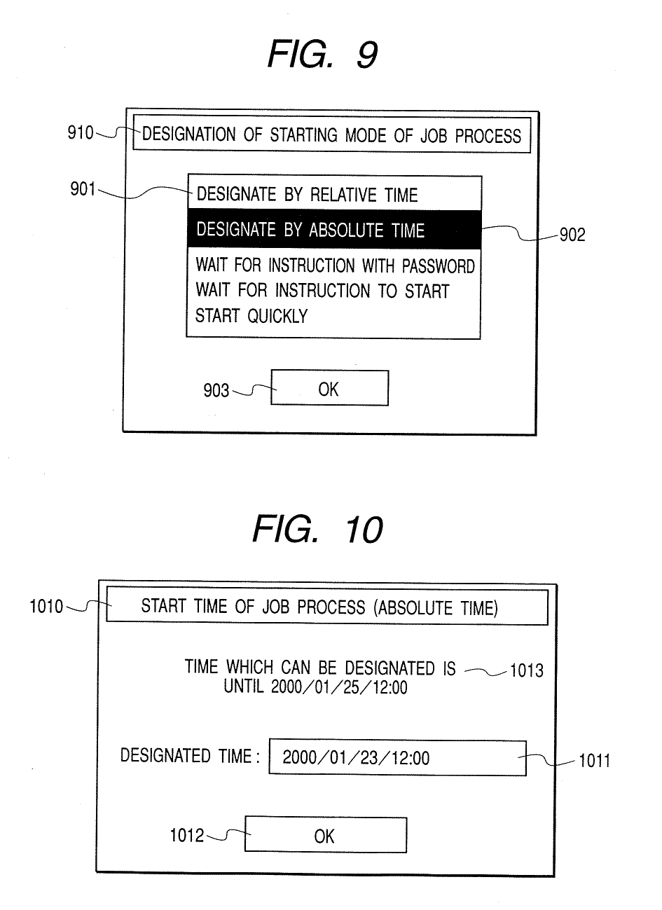

FIG. 9 is a diagram showing an example of a first user interface which is displayed on a display apparatus on each PC shown in FIG. 3. FIG. 9 shows a picture plane on which the user sets the “starting mode of a job process” attribute when the job is inputted into the peripheral apparatus in FIG. 1. This picture plane is displayed on the display apparatus of the PC(1) 302, PC(2) 303, or PC(3) 304 in FIG. 3 or on the user I/F 106 in FIG. 1.

It is assumed that in the PC(1) 302, PC(2) 303, or PC(3) 304 in FIG. 3, the driver software has obtained the list of the values which can be set into the “starting mode of a job process” attribute on the basis of the procedure for the process to obtain the apparatus information shown in FIG. 8 before the picture plane in FIG. 9 is formed.

In FIG. 9, a title 910 of the setting picture plane shows a simple explanation of this setting picture plane and shows that this setting picture plane is displayed to designate the value of the “starting mode of a job process” attribute. A list box 901 displays a list of attribute values which can be set into the “starting mode of a job process” attribute to the peripheral apparatus in FIG. 1 obtained by the flow for the obtaining process of the apparatus information shown in FIG. 8. The attribute values which are listed in the list box 901 correspond to the values listed in the list of the values which can be set into the “starting mode of a job process” attribute in FIG. 9 in a one-to-one correspondence relational manner.

The user can select a desired set value from the list box 901 by the keyboard 404 or the pointing device 405. Reverse indication 902 shows the value of the “starting mode of a job process” attribute selected at present. In FIG. 9, “designate by absolute time” has been selected. An OK button 903 is a button to decide the attribute value of the attribute of the inputted job to the value shown by the reverse indication 902.

FIG. 10 is a diagram showing an example of a second user interface which is displayed on the display apparatus on each PC shown in FIG. 3. If the user designates “designate by absolute time” on the setting picture plane of the “starting mode of a job process” attribute shown in FIG. 9, this setting picture plane is used by the user in order to designate time when he wants to start the job process. This picture plane is displayed on the display apparatus of the PC(l) 302, PC(2) 303, or PC(3) 304 in FIG. 3 or on the user I/F 106 in FIG. 1.

It is assumed that the PC(l) 302, PC(2) 303, or PC(3) 304 in FIG. 3 or the user I/F 106 in FIG. 1 which displays the setting picture plane shown in FIG. 10 has obtained “the maximum value of the elapsed time which can be designated as execution start time of the job” by the procedure for the obtaining process of the apparatus information shown in FIG. 8 before the setting picture plane shown in FIG. 10 is formed.

In FIG. 10, a title 1010 of the setting picture plane shows a simple explanation of this setting picture plane and shows that this setting picture plane is displayed to designate the start time of the job process by the absolute time. The absolute time when the user wants to start the job process is inputted into an edit box 1011 and designated. An OK button 1012 is a button for determining the designated time to start the process of the inputted job to the value inputted to the edit box 1011.

A text 1013 shows a range of the time which can be set by the user in FIG. 10. In FIG. 10, “the maximum value of the elapsed time which can be designated as execution start time of the job” is equal to two days. By calculating from this value, as a maximum value of the absolute time which can be designated, “Jan. 25, 2000 A.D., at 12:00 (2000/01/25/12:00)” is displayed in the text 1013.

Also in the case where the user designates “designate by relative time” in FIG. 9, the start time of the job process can be designated by the relative time by a setting picture plane similar to that shown in FIG. 10 and the maximum value of the relative time which can be designated is displayed.

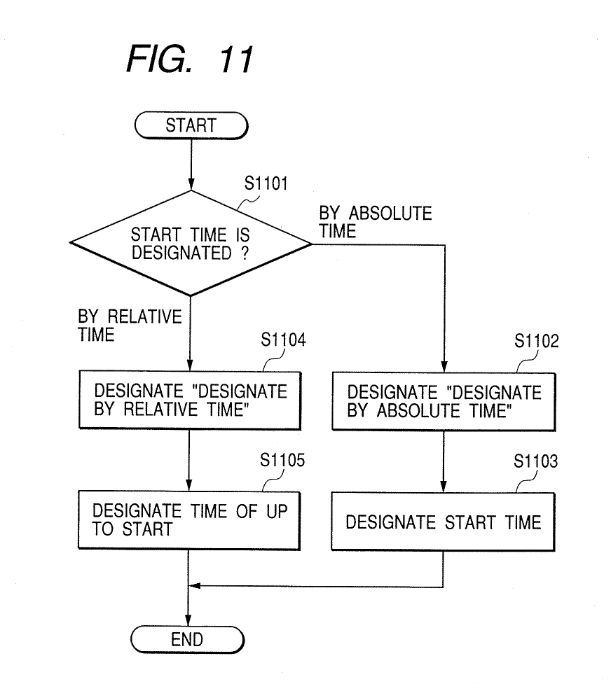

FIG. 11 is a flowchart showing an example of a second data processing procedure in the information processing apparatus according to the invention and corresponds to a processing procedure for designating the start time of the job process by the driver software by using the “starting mode of a job process” attribute when the job is inputted to the peripheral apparatus in FIG. 1. S1101 to S1105 denote processing steps.

First, in step S1101, which mode is desired (designated) as a starting mode of the job process is discriminated. If it is determined that the user desires the mode for executing the job at the designated time and date, step S1102 follows. If it is determined that the user desires to designate the mode for executing the job after the designated elapsed time after the job had been inputted, step S1104 follows.

In step S1102, “designate by absolute time” is selected and determined (OK button is pressed) on the setting picture plane of the “starting mode of a job process” attribute shown in FIG. 9 and step S1103 follows.

Subsequently, in step S1103, start time of the desired job process is inputted by the absolute time and determined on the picture plane to designate the absolute time shown in FIG. 10 and, thereafter, the processing routine is finished.

On the other hand, in step S1104, “designate by relative time” is selected and determined on the setting picture plane of the “starting mode of a job process” attribute shown in FIG. 9 and step S1105 follows. Start time of the desired job process is inputted by the relative time and determined on the picture plane to designate the relative time similar to that of FIG. 10 and, thereafter, the processing routine is finished.

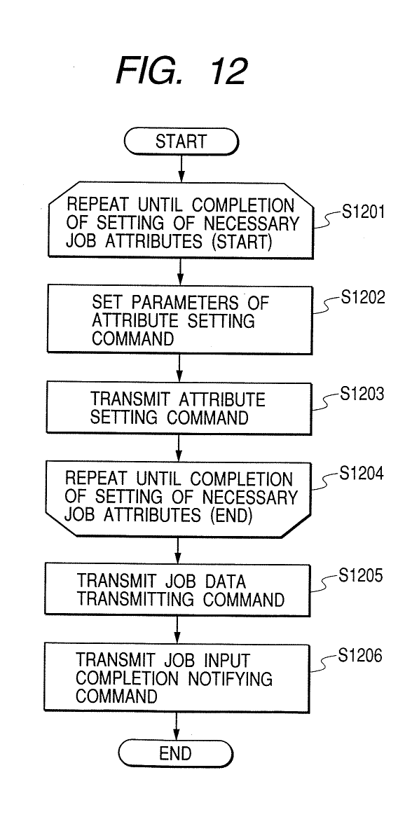

FIG. 12 is a flowchart showing an example of a third data processing procedure in the information processing apparatus according to the invention and corresponds to a processing procedure in the case where the driver software inputs the job to the peripheral apparatus in FIG. 1. S1201 to S1206 denote processing steps.

First, processes in steps S1201 to S1204 are repeated until the setting of the attributes necessary for the job process desired by the driver software is completed. In step S1202, parameters of an attribute setting command are set in order to set the attributes of the job as shown in the attribute list 501 shown in FIG. 5 in accordance with the job process desired by the driver software.

The attributes which can be set by the driver software among the attributes of the job are attributes which are listed in the “list of attributes supported by the job” shown in FIG. 6 which is obtained by the processing procedure shown in FIG. 8, the column 611 is “TRUE”, and this attribute can be set.

The values which can be set into this attribute are shown in the “list of values which can be set” shown in FIG. 7 which is obtained by the processing procedure shown in FIG. 8.

In step S1203, the attribute setting command formed in step S1202 is transmitted to the peripheral apparatus to which the job is going to be inputted. In step S1205, the data serving as a target of the job process such as image data or the like formed by the application or the like is transmitted to the peripheral apparatus by a job data transmitting command. In step S1206, a job input completion notifying command indicative of the completion of transmission of a job input command is transmitted. The processing routine is finished.

By the above series of job inputting processes, the job as shown in FIG. 5 is formed in the peripheral apparatus.

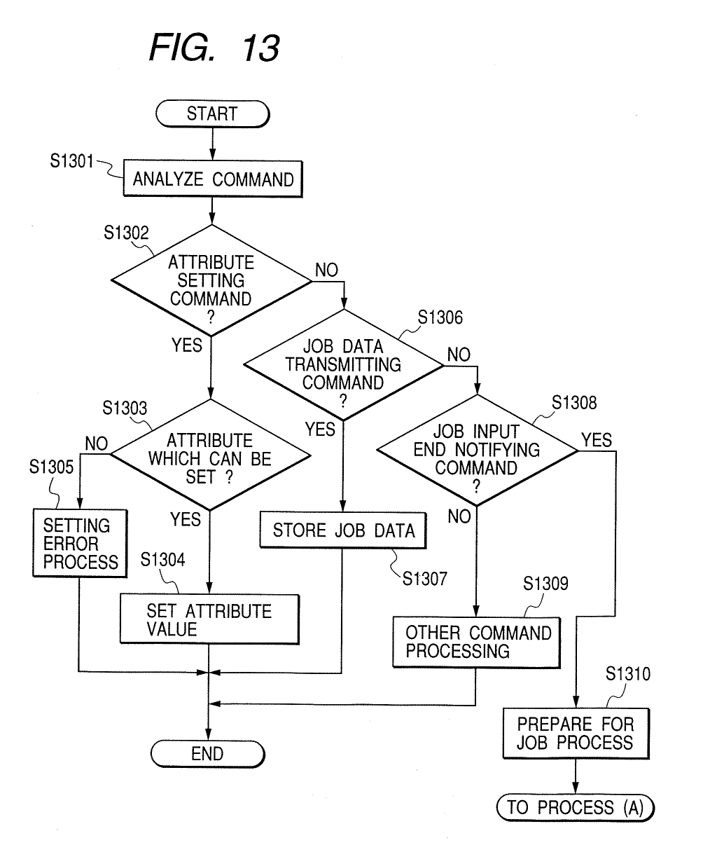

FIG. 13 is a flowchart showing an example of a first data processing procedure in the peripheral apparatus according to the invention and corresponds to a processing procedure at the time when the peripheral apparatus in FIG. 1 receives the job input command from the driver software. S1301 to S1310 denote processing steps.

First, in step S1301, the peripheral apparatus shown in FIG. 1 analyzes the command received from the driver software and its parameters and holds an analysis result, and step S1302 follows. In step S1302, whether the received command is an attribute setting command or not is discriminated from the analysis result in step S1301. If it is determined that the received command is the attribute setting command, step S1303 follows. If it is determined that the received command is not the attribute setting command, step S1306 follows.

In step S1303, the “list of attributes supported by the job” shown in FIG. 6 and the analysis result obtained in step S1301 are checked, thereby discriminating whether the attribute designated by the received attribute setting command can be set or not. If it is determined that the attribute can be set, step S1304 follows. If it is determined that the attribute cannot be set, step S1305 follows.

In step S1304, the designated attribute value is set into the designated attribute in accordance with the analysis result obtained in step S1301. The processing routine is finished.

In step S1305, the attribute designated by the received attribute setting command cannot be set and the driver software is notified of the fact that the attribute cannot be set. The processing routine is finished.

In step S1306, whether the received command is the job data transmitting command or not is discriminated from the analysis result obtained in step S1301. If it is determined that the received command is the job data transmitting command, step S1307 follows. If it is determined that the received command is not the job data transmitting command, step S1308 follows.

In step S1307, the job data which is received subsequently to the command is held in the RAM 202 or the DISK 210 shown in FIG. 2. The processing routine is finished.

In step S1308, whether the received command is the job input end notifying command or not is discriminated from the analysis result obtained in step S1301. If it is determined that the received command is the job input end notifying command, step S1310 follows. If it is determined that the received command is not the job input end notifying command, step S1309 follows.

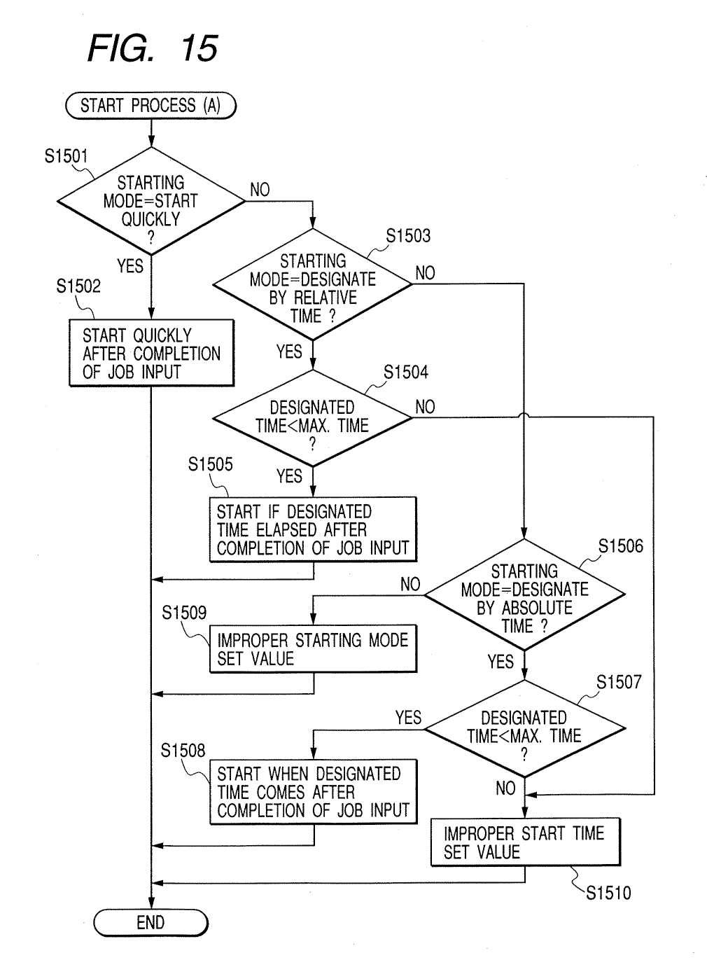

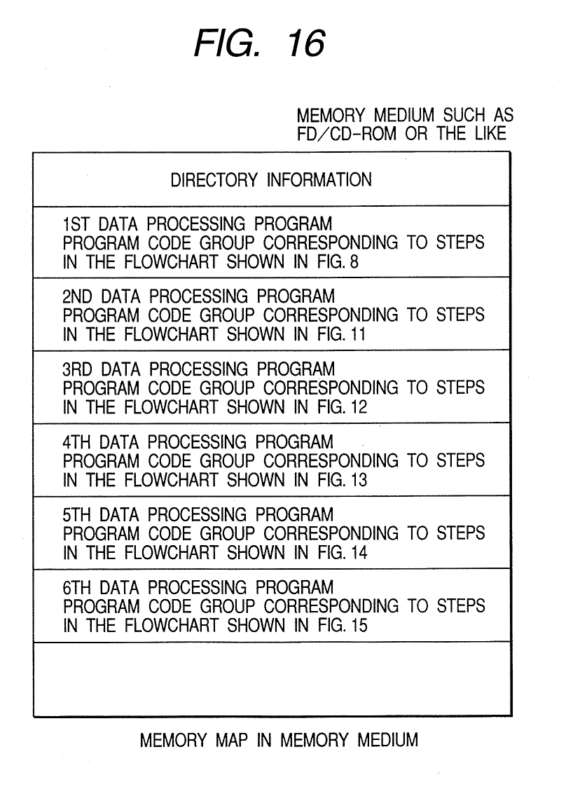

In step S1310, preparation for the start of the job process is made and in order to discriminate starting conditions of the job process, the processing routine advances to a process (A) shown in FIG. 15.

In step S1309, the received command is one of the other commands and a process corresponding to each of them is executed. The processing routine is finished.

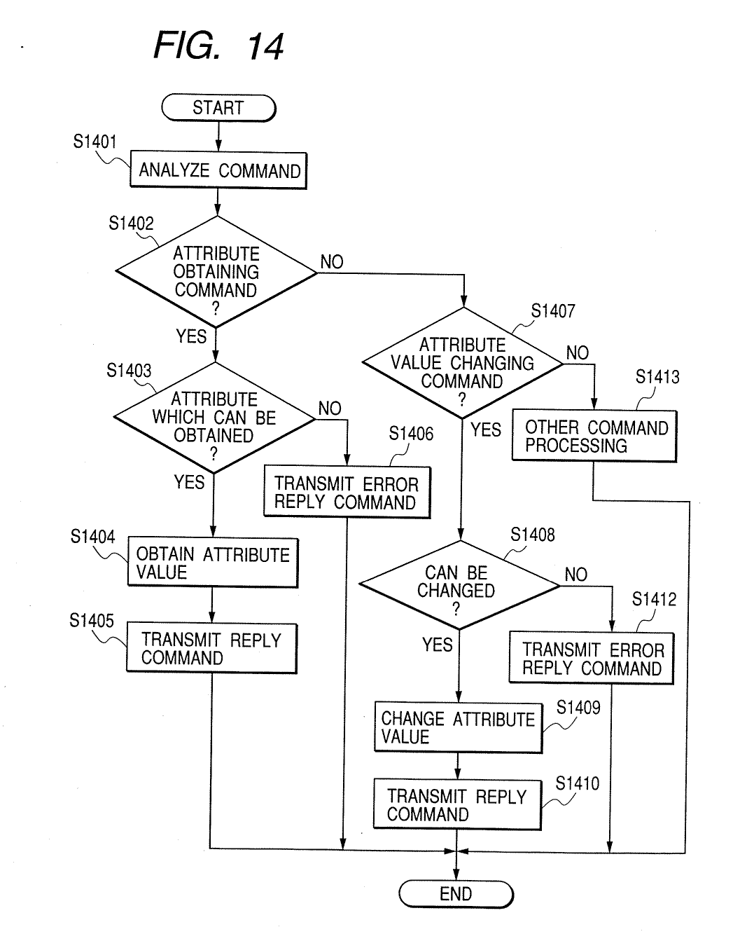

FIG. 14 is a flowchart showing an example of a second data processing procedure in the peripheral apparatus according to the invention and corresponds to a processing procedure at the time when the peripheral apparatus shown in FIG. 1 receives an access command to access the attribute of the job from the driver software. S1401 to S1413 denote processing steps.

First, in step S1401, the received command and its parameters are analyzed and step S1402 follows. Whether the received command is an attribute obtaining command or not is discriminated from an analysis result in step S1401. If it is determined that the received command is the attribute obtaining command, step S1403 follows. If it is determined that the received command is not the attribute obtaining command, step S1407 follows.

In step S1403, whether the attribute designated by the attribute obtaining command can be obtained or not is discriminated. If it is determined that the attribute can be obtained, step S1404 follows. If it is determined that the attribute cannot be obtained, step S1406 follows.

In step S1404, the value of the attribute held in the peripheral apparatus is obtained and step S1405 follows. The attribute value obtained in step S1404 is set into the parameters of a reply command and the reply command to the attribute obtaining command is transmitted to the driver software. The processing routine is finished.

In step S1406, a process for notifying the driver software of the fact that the obtainment of the attribute failed is executed. The processing routine is finished.

In step S1407, whether the received command is an attribute value changing command or not is discriminated from the analysis result obtained in step S1401. If it is determined that the received command is the attribute value changing command, step S1408 follows. If it is determined that the received command is not the attribute value changing command, step S1413 follows.

In step S1408, whether the attribute designated by the attribute value changing command can be changed or not is discriminated. If it is determined that the attribute can be changed, step S1409 follows. If it is determined that the attribute cannot be changed, step S1412 follows.

In step S1409, the designated attribute is changed to the designated attribute value in accordance with the designated command parameter and step S1410 follows. A process for notifying the driver software of the fact that the attribute value has successfully been changed is executed. The processing routine is finished.

In step S1412, a process for notifying the driver software of the fact that the change of the attribute value failed is executed. The processing routine is finished.

In step S1413, the received command is one of the other command and a process corresponding to each of them is executed. The processing routine is finished.

FIG. 15 is a flowchart showing an example of a third data processing procedure in the peripheral apparatus according to the invention and corresponds to a processing procedure of the inputted job which is executed after step S1310 shown in FIG. 13. S1501 to S1510 denote processing steps.

First, in step S1501, whether the value of the “starting mode of a job process” attribute is “start quickly” or not is discriminated. If it is determined that the value is “start quickly”, step S1502 follows and the job process is quickly started. The processing routine is finished.

If it is determined in step S1501 that the value is not “start quickly”, step S1503 follows and whether the value of the “starting mode of a job process” attribute is “designate by relative time” or not is discriminated. If it is determined that the value is “designate by relative time”, step S1504 follows. Whether the designated relative time does not exceed the maximum value of the elapsed time which can be designated or not is discriminated. If it is determined that the value does not exceed the maximum value of the elapsed time, in step S1505, the inputted job is held and the apparatus waits until the elapse of the designated time. If the designated time elapsed, the job process is started. The processing routine is finished.

If it is determined in step S1503 that the value is not “designate by relative time”, whether the value of the “starting mode of a job process” attribute is “designate by absolute time” or not is discriminated in step S1506. If it is determined that the value is “designate by absolute time”, step S1507 follows. Further, the designated absolute time is compared with the present time, thereby discriminating whether the designated absolute time does not exceed the maximum value of the elapsed time which can be designated or not. If it is determined that the designated absolute time does not exceed the maximum value of the elapsed time which can be designated, the inputted job is held, and the apparatus waits until the designated absolute time comes in step S1508. If the designated absolute time elapsed, the job process is started. The processing routine is finished.

If it is determined in step S1506 that the value of the “starting mode of a job process” attribute is not “designate by absolute time”, the value of the designated “starting mode of a job process” attribute is determined to be improper and an error process is executed in step S1509. The processing routine is finished.

In step S1507, whether the designated absolute time does not exceed the maximum value of the elapsed time which can be designated or not is discriminated. If it is determined that the designated absolute time exceeds the maximum value of the elapsed time which can be designated, it is regarded that the value exceeding the maximum value of the elapsed time which can be designated has been designated as start time of the job process. An error process is executed in step S1510 as the start time setting value is improper. The processing routine is finished.

A construction of data processing programs which can be read out by an image processing system to which the information processing apparatus and the peripheral apparatus according to the invention can be applied will be described hereinbelow with reference to a memory map shown in FIG. 16.

FIG. 16 is a diagram for explaining the memory map of a memory medium for storing various data processing programs which can be read out by the image processing system to which the information processing apparatus and the peripheral apparatus according to the invention can be applied.

Although not shown in particular, there is also a case where information for managing a group of programs which are stored into the memory medium, for example, version information, an implementor, and the like are also stored and information depending on an OS (Operating System) or the like on the program reading side, for example, icons or the like for identifying and displaying the programs are also stored.

Further, data depending on the various kinds of programs has also been managed in the directory. There is also a case where a program to install the various kinds of programs into a computer or, if the installing program has been compressed, a program for decompressing the program and the like are also stored.

The functions shown in FIGS. 8, 11, 12, 13, 14, and 15 in the embodiment can be executed by a host computer in accordance with a program which is installed from an outside. In this case, the invention is also applied to the case where an information group including the program is supplied to an output apparatus by a memory medium such as CD-ROM, flash memory, FD, or the like or from an external memory medium via a network.

Naturally, the objects of the invention are also accomplished by a method whereby a memory medium in which program codes of software to realize the functions of the embodiment have been recorded as mentioned above is supplied to the system or the apparatus and a computer (or a CPU or an MPU) of a system or an apparatus reads out and executes the program codes stored in the memory medium.

In this case, the program codes themselves read out from the memory medium realize the novel functions of the invention and the memory medium in which the program codes have been stored constructs the invention.

As a memory medium for supplying the program codes, for example, a flexible disk, a hard disk, an optical disk, a magnetooptic disk, a CD-ROM, a Cd-2, a magnetic tape, a non-volatile memory card, a ROM, an EEPROM, or the like can be used.

Naturally, the invention incorporates not only a case where a computer executes the read-out program codes, so that the functions of the invention as mentioned above are realized but also a case where an OS (Operating System) or the like which is operating on the computer executes a part or all of actual processes on the basis of instructions of the program codes and the functions of the invention as mentioned above are realized by those processes.

Further, naturally, the invention incorporates a case where the program codes read out from the memory medium are written into a memory provided for a function expanding board inserted in a computer or a function expanding unit connected to a computer and, thereafter, a CPU or the like provided for the function expanding board or the function expanding unit executes a part or all of actual processes on the basis of instructions of the program codes and the functions of the invention as mentioned above are realized by those processes.

If the peripheral apparatus has one or a plurality of starting modes of the job process as described above, a device driver or a software program on the information processing apparatus can recognize the starting modes provided for the peripheral apparatus.

The device driver or the software program easily recognizes the presence or absence of the starting modes provided for the peripheral apparatus and clearly presents the starting moaes to the user, thereby enabling the user to freely designate the desired starting mode.

1-6. (canceled)

7. An information processing apparatus which can communicate with a data processing apparatus for processing a job from said information processing apparatus, wherein the data processing apparatus holds
attribute information showing one or a plurality of starting modes which can be designated as a starting mode of the job to be processed by the data processing apparatus among a plurality of kinds of starting modes which have respective different conditions on which the data processing apparatus starts the process of the job, said information processing apparatus comprising:
an obtaining unit adapted for obtaining the attribute information from the data processing apparatus; and
a control unit adapted for displaying a list of the one or the plurality of starting modes on a display unit on the basis of the attribute information obtained by said obtaining unit.

8. An information processing method which is executed by an information processing apparatus which can communicate with a data processing apparatus for processing a job from said information processing apparatus, wherein the data processing apparatus holds
attribute information showing one or a plurality of starting modes which can be designated as a starting mode of the job to be processed by the data processing apparatus among a plurality of kinds of starting modes which which have respective different conditions on which the data processing apparatus starts the process of the job said information processing method comprising:
an obtaining step of obtaining the attribute information from the data processing apparatus; and
a control step of displaying a list of the one or the plurality of starting modes on a display unit on the basis of the attribute information obtained by said obtaining step.

9. A method according to claim 8, further comprising a picture plane displaying step of, when the user selects a desired starting mode from the displayed list of the starting modes, displaying an input picture plane for inputting a designation value corresponding to the selected starting mode.

10. A method according to claim 8, further comprising:
a selecting step of allowing the user to select a desired starting mode from the displayed list of the starting modes; and
a transmitting step of transmitting an attribute setting command for setting the attribute value indicative of the selected starting mode to said data processing apparatus.

11. A program for controlling an information processing apparatus which can communicate with a data processing apparatus for processing a job, from said information processing apparatus, wherein the data processing apparatus holds
attribute information showing one or a plurality of starting modes which can be designated as a starting mode of job to be processed by the data processing apparatus among a plurality of kinds of starting modes which have respective different conditions on which the data processing apparatus starts the process of the job, wherein said program allows the computer to execute:
an obtaining step of obtaining the attribute information from the data processing apparatus; and
a control step of displaying a list of the one or the plurality of starting modes on a display unit on the basis of the attribute information obtained by said obtaining step.

12. A program according to claim 11, wherein said program allows the computer to further execute a picture plane displaying step of, when the user selects a desired starting mode from the displayed list of the starting modes, displaying an input picture plane for inputting a designation value corresponding to the selected starting mode.

13. A program according to claim 11, wherein said program allows the computer to further execute:
a selecting step of allowing the user to select a desired starting mode from the displayed list of the starting modes; and
a transmitting step of transmitting an attribute setting command for setting the attribute value indicative of the selected starting mode to said data processing apparatus.
